(19) United States
(12) Patent Application Publication
(10) Pub. No.: US 2007/0235590 A1
(43) Pub. Date: Oct. 11, 2007

(54) VORTEX GENERATOR

(76) Inventors: Roman Nikolayevich Kokoshkin, Saint-Petersburg (RU); Igor Sergeevich Zegshda, Saint-Petersburg (RU); Alexey Anatolievich Lotarev, Saint-Petersburg (RU); Vasiliy Gennadievich Abashkin, Saint-Petersburg (RU); Andrey Vyacheslavovich Efimov, Saint-Petersburg (RU); Alexander Vitaliyevich Medvedev, Saint-Petersburg (RU)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 11/669,463

(22) Filed: Jan. 31, 2007

Related U.S. Application Data
(60) Provisional application No. 60/764,080, filed on Jan. 31, 2006.

(51) Int. Cl. B64C 1/38

(52) U.S. Cl. 244/130

(57) ABSTRACT

The present invention provides a vortex generator that in one embodiment includes an apex having a first width; a rear face having a second width being greater than the first width; a first and second sidewall each extending from the first width of the apex to the second width of the rear face, wherein at least a portion of each of the first and second sidewall have a peak including a convex surface; and a concave work surface positioned between the peak of the first and the second sidewall, wherein the concave work surface has an intake at the apex and an outlet at the rear face. In another embodiment, the exterior faces of the sidewalls include a planar surface.

### CROSS REFERENCE TO RELATED APPLICATIONS

The present invention claims the benefit of U.S. provisional patent application 60/764,080 filed Jan. 31, 2006 the whole contents and disclosure of which is incorporated by reference as is fully set forth herein.

### FIELD OF THE INVENTION

The present invention relates to a structure that in one embodiment reduces aerodynamic drag in transportation systems.

### BACKGROUND OF THE INVENTION

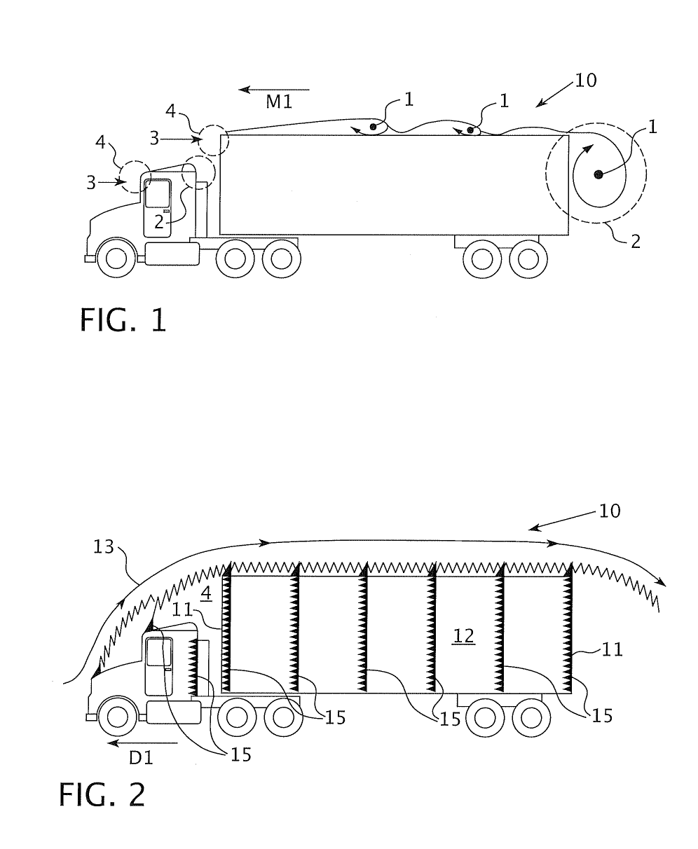

Aerodynamic drag is typically due to some form of separation, such as air flow separation. Air flow separation typically occurs at the lateral surfaces of motor vehicles and behind the trailing surfaces of the moving vehicle 10, and typically results in the formation of vortices 1 having an axis of flow that is perpendicular to the direction M1 in which the motor vehicle is moving, as depicted in FIG. 1. Air flow separation is generally associated with adverse pressure gradients formed behind the rear surfaces 2 of the moving vehicle 10. Further, resistance to forward motion M1 of the vehicle 10 also increases as the airflow pressure 3 on the front surfaces 4 of the vehicle 10 is increased.

### SUMMARY OF THE INVENTION

Generally speaking, the present invention provides a vortex generator that reduces the aerodynamic drag of motor vehicles. In one embodiment, the inventive vortex generator includes:
an apex having a first width;
a rear face having a second width being greater than the first width;
a first and second sidewall each extending from the first width of the apex to the second width of the rear face, wherein at least a portion of the exterior face of each of the first and second sidewall have a peak including a convex surface; and
a concave work surface positioned between the peak of the first and the second sidewall, wherein the concave work surface has an intake at the apex and an outlet at the rear face.

The convex surface of the first and second sidewall of the vortex generator of the present invention may be positioned at an upper portion of the sidewalls, wherein a concave surface is positioned in a lower portion of the sidewall. The concave work surface may be further characterized as having a cone geometry curvature in which the radii of curvature increases from the intake at the apex of the vortex generator to the outlet at the rear face of the vortex generator. In one embodiment, a vortex or vortice is an airflow that is directed in a motion about an axis of rotation.

In another embodiment, the vortex generator in accordance with the present invention includes:
an apex having a first width;
a rear face having a second width being greater than the first width;
a first and second sidewall each extending from the first width of the apex to the second width of the rear face; and
a concave work surface positioned between the first and the second sidewall,
wherein the concave work surface has an intake at the apex and an outlet at the rear face.

In one embodiment, the concave surface further comprises a substantially planar channel at the base of the concave surface extending from the intake of the apex to the outlet of the rear portion of the vortex generator.

In one embodiment, the vortex generator is installed with the apex facing the direction in which the vehicle is moving in the forward direction, wherein airflow passes over the exterior surfaces of each of the sidewalls and into and continuing their motion along the concave working surface, wherein each sidewall produces an airflow swirl resulting in the formation of a vortex, more particularly two vortices, one vortex corresponding to each sidewall, where the vortices have an axis of rotational airflow that is substantially parallel to the longitudinal axis of the vortex generator. In one embodiment, the angle of inclination of the concave working surface from the apex of the vortex generator to the rear face of the vortex generator is selected to provide vortices with a rotation axis having an angle to direct airflow above high pressure surfaces positioned to the rear of the point at which the vortex generator is mounted.

### DETAILED DESCRIPTION OF THE DRAWINGS

The following detailed description, given by way of example and not intended to limit the invention solely thereto, will best be appreciated in conjunction with the accompanying drawings, wherein like reference numerals denote like elements and parts, in which:

FIG. 1 is a side view depicting airflow separation in forward moving tractor and trailer bodies.

FIG. 2 is a side view of depicting the aerodynamic flow in a tractor and trailer combination including one embodiment of vortex generators, in accordance with the present invention.

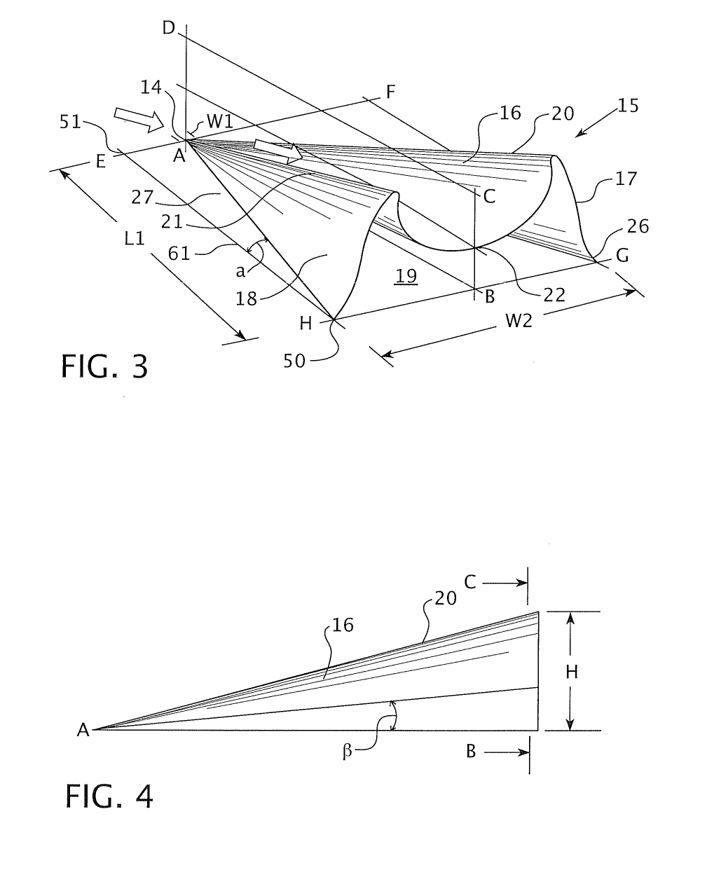

FIG. 3 is a perspective view of one embodiment of a vortex generator, in accordance with the present invention.

FIG. 4 is a cross section view of one embodiment of a vortex generator, wherein the cross sectional view is along the plane ABCD, as depicted in FIG. 3.

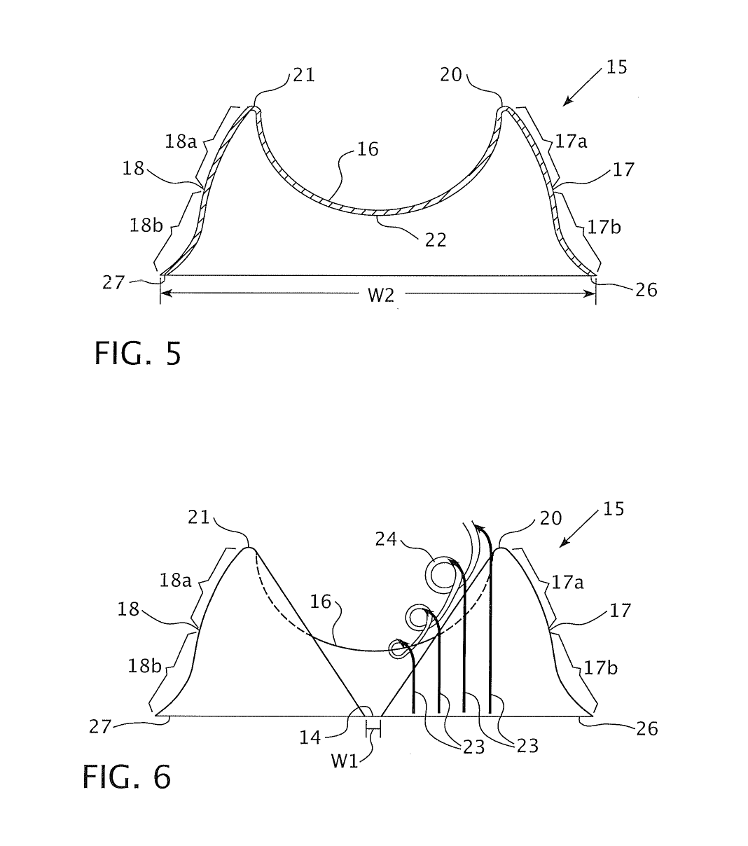

FIG. 5 is a cross sectional front end view of one embodiment of a vortex generator in accordance with the present invention, as depicted FIG. 3.

FIG. 6 is a front end view of one embodiment of a vortex generator in accordance with the present invention depicting the formation of vortices flowing from the sidewall to the central working surfaces of the vortex generator.

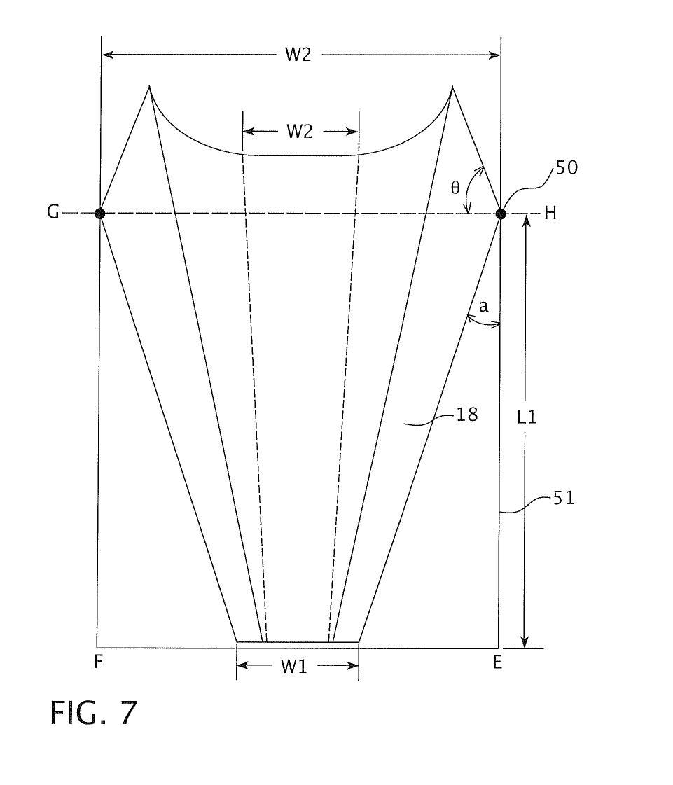

FIG. 7 is a perspective view of one embodiment of a vortex generator having a substantially planar sidewall.

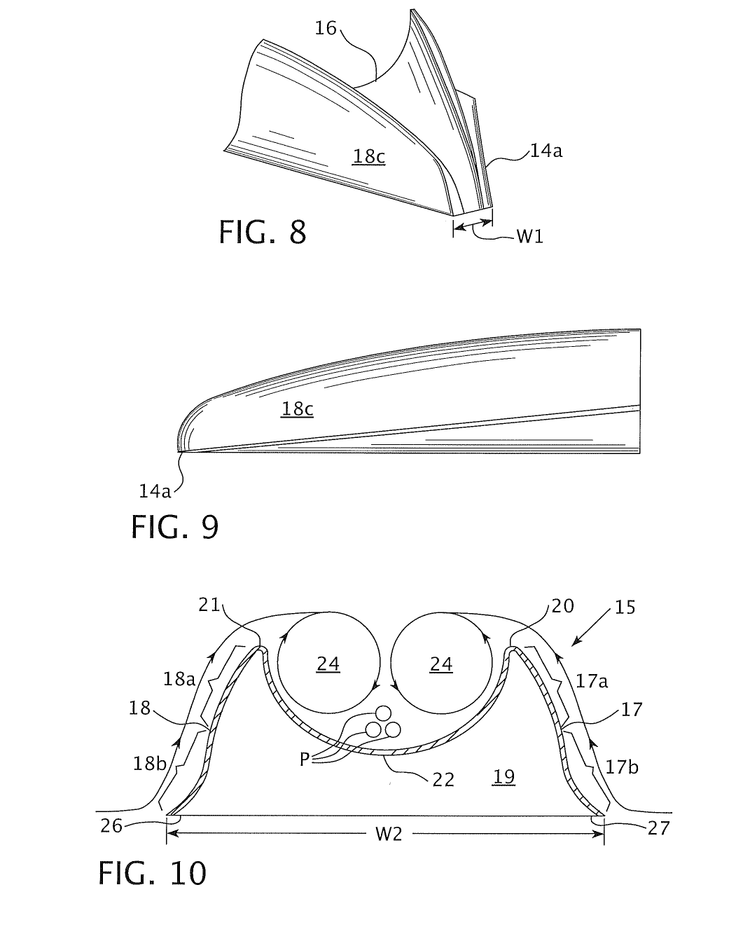

FIG. 8 is a perspective view of one embodiment of a vortex generator having an enlarged apex portion, in accordance with the present invention.

FIG. 9 is a side view of one embodiment of a vortex generator, as depicted in FIG. 8.

FIG. 10 is a cross sectional end view depicting vortices generation in one embodiment of a vortex generator as depicted in FIG. 3.

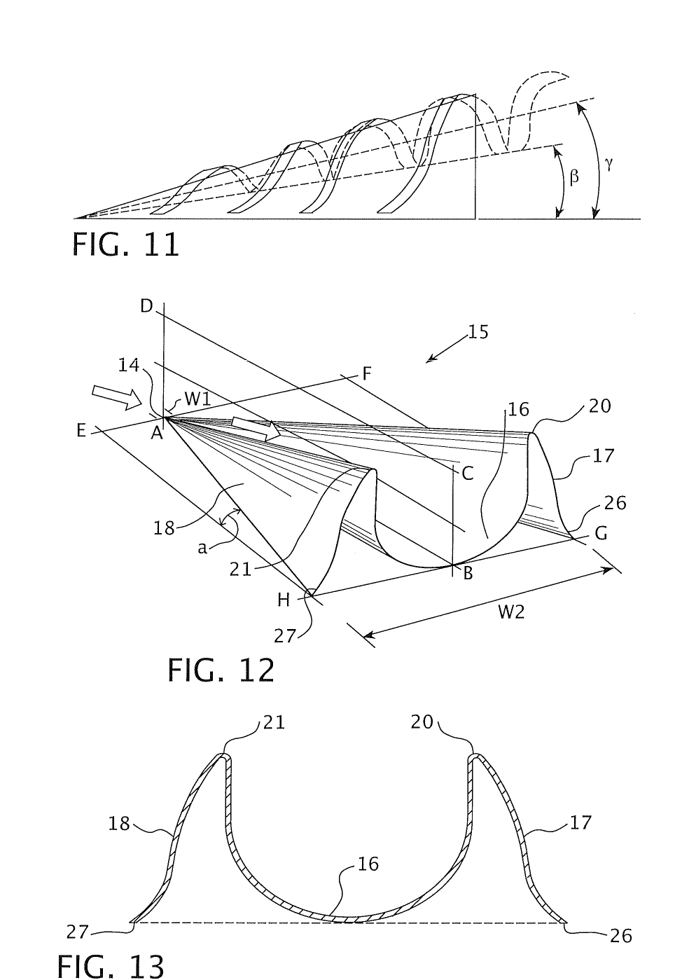

FIG. 11 is a side view of one embodiment of a vortex generator in accordance with the present invention depicting the formation of vortices flowing from the lateral surfaces to the concave working surfaces of the vortex generator.

FIG. 12 is a perspective view of one embodiment of a vortex generator, in accordance with the present invention.

FIG. 13 is a cross sectional rear end view of the vortex generator of the embodiment of the vortex generator depicted in FIG. 12.

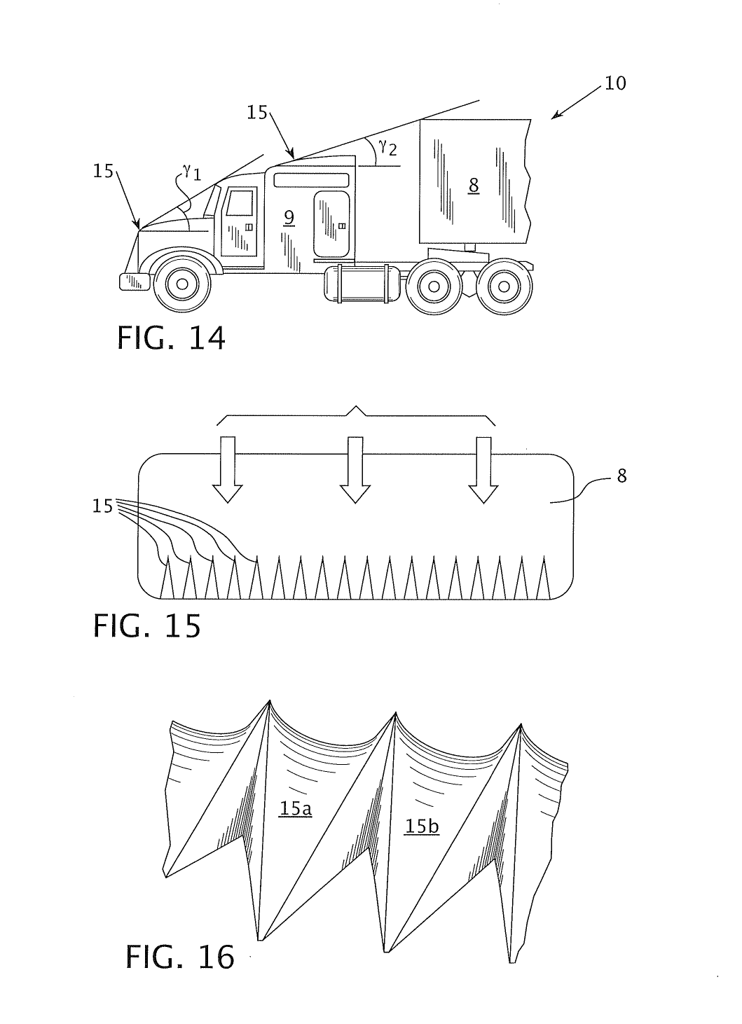

FIG. 14 is a side view of a tractor and trailer combination in which the vortex generators are configured to direct airflow past the front surfaces of the cab and trailer.

FIG. 15 is a top view of one embodiment of an arrangement of vortex generators, in which a number of vortex generators are configured into a roof fairing design.

FIG. 16 is a perspective view of one embodiment of an arrangement of vortex generators, in which a gap is not present between adjacent vortex generators.

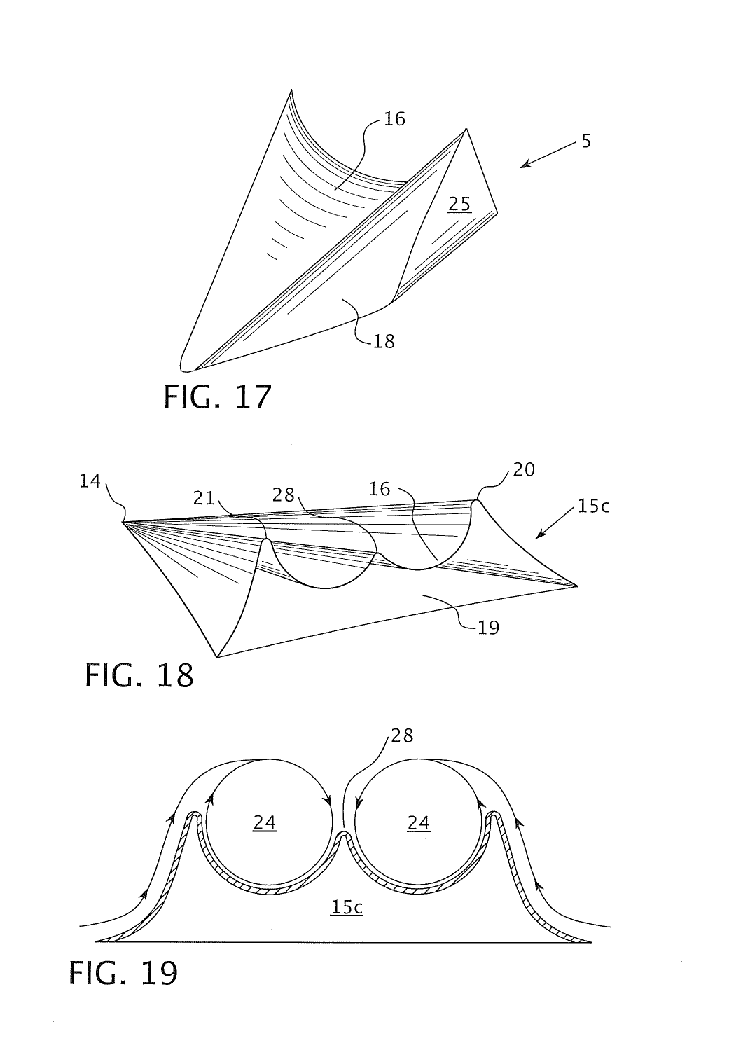

FIG. 17 is a perspective view of one embodiment of a vortex generator configured for an abutting relationship to an adjacent vortex generator.

FIG. 18 is a perspective view of one embodiment of a vortex generator, in accordance with the present invention.

FIG. 19 is a cross sectional rear end view depicting vortices generation in one embodiment of a vortex generator as depicted in FIG. 18.

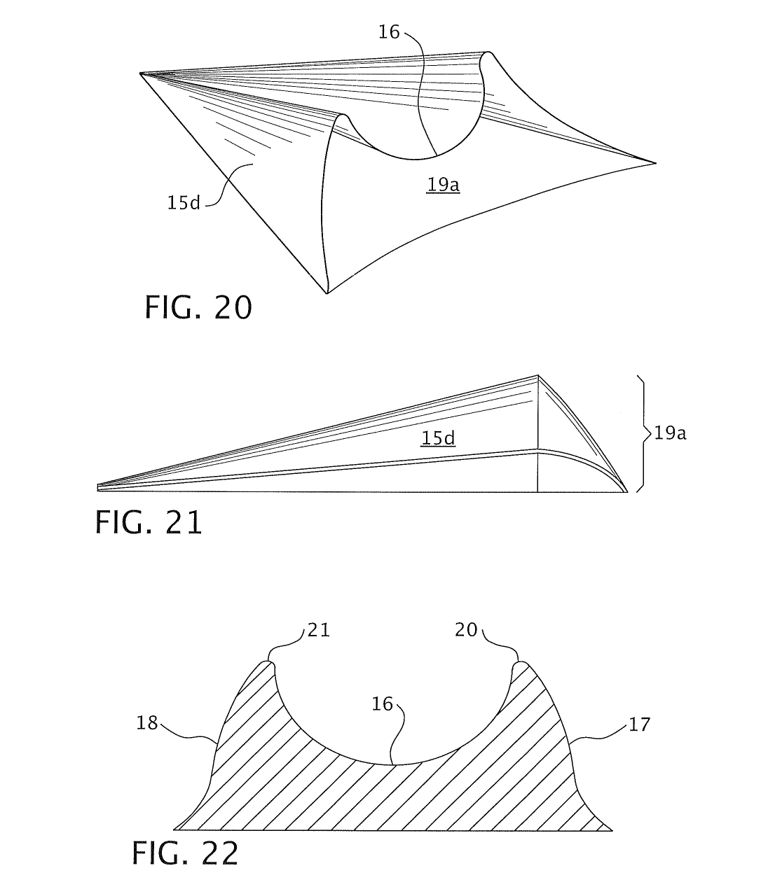

FIG. 20 is a perspective view of one embodiment of a vortex generator, in accordance with the present invention.

FIG. 21 is a side view of one embodiment of a vortex generator, as depicted in FIG. 20.

FIG. 22 is a cross sectional end view depicting one embodiment of a cast vortex generator.

### DETAILED DESCRIPTION OF PREFERRED EMBODIMENTS

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

For the purposes of the description hereinafter, the terms “upper”, “lower”, “front”, “rear”, “top” and “bottom”, and derivatives thereof shall relate to the invention, as orientated in the embodiments depticted in the figures.

Referring to FIG. 2, in one embodiment a reduction of aerodynamic drag is provided by an arrangement of vortex generators 15 that reduces the effects of flow separation at the lateral surfaces 12 and trailing edges 11 of the vehicle 10, and by directing airflow 13 (also referred to air curtain) to reduce pressure increases at the front surfaces of the vehicle. The lateral surfaces include the top and side surfaces of a vehicle. For example, in a trailer configuration the lateral surfaces include the top surface (also referred to as roof) and sidewalls of the trailer, which in at least one embodiment are substantially planar.

In one embodiment, at least one of separation at the lateral 12 and trailing edges 11 of the vehicle 10 and the reduction of pressure at the front surfaces 4 of the vehicle 10 is produced by vortex generators 15 that provide airflow vortices having a rotational axis that is substantially parallel to the direction D1 in which the vehicle 10 is moving forward.

In one embodiment, the vortex arrangement by reducing pressure to the front surfaces 4 of the vehicle 10 and by reducing flow separation to the lateral surfaces 12 of the moving vehicles provides an air curtain 13 that results in an aerodynamic effect. In one embodiment, the term rotational axis denotes the axis about which the air flow rotationally encircles when exiting the vortex generator in providing vortices. In one embodiment, the present invention reduces the effects of vortices having a rotational axis being perpendicular to the direction of vehicle motion by producing vortices having a rotational axis that is substantially parallel to the vehicle motion.

FIGS. 3-6 depict one embodiment of a vortex generator 15 including an apex 14, a concave work surface 16 and a first and second sidewall 17, 18. The apex 14 represents the front face of the vortex generator 15, which faces the direction in which the vehicle 10 moves forward. In one embodiment, the apex 14 may have a width W1 ranging from 10 mm to 40 mm. In one embodiment, the apex 14 may have a width W1 on the order of 30 mm. In one embodiment, the apex 1 may include an air intake having sidewalls extending to the upper edges 21, 22 of the first and second sidewalls 17, 18, which extend from the apex 14 to the outlet at substantially the rear portion 19 of the vortex generator 15.

In one embodiment, the first and second sidewalls 17, 18 diverge from a centerline extending from the point A to point B along a horizontal axis defined by points H and G from a first width W1 at the apex 14 to a second width W2 at the base of the rear portion 19 of the vortex generator 15. In one embodiment, the width W2 of the base of the rear (outlet) portion 19 of the vortex generator 15 is defined by the dimension defined between points H and G may range from about 85 mm to about 115 mm. In one embodiment, the width W2 of the base of the rear portion 19 of the vortex generator 15 may be on the order of 100 mm. In one embodiment, the longitudinal length L1 of the vortex generator 15 measured from the apex 14 to the rear outlet surface 19 of the vortex generator 15 may range from 140 mm to 190 mm. In one embodiment, the longitudinal length L1 may be on the order of 165 mm. It is noted that other dimensions for the apex width W1, rear portion width W2, and longitudinal length L1 of the vortex generator 15 have been contemplated and are within the scope of the present invention.

The concave work surface 16 is positioned between the first and second sidewall 17, 18 and extends along the longitudinal direction of the vortex generator 15 from the apex 14 to the rear face 19 of the vortex generator 15. In one embodiment, the concave work surface 16 is defined by an arc extending from the upper edge 20, 21 of each of the first and second sidewall 17, 18, in which the lowest point 22 of the arc of the concave work surface 16 corresponds to the centerline A-B of the vortex generator 15. In one embodiment, the concave work surface 16 has a cone geometry curvature. The term cone geometry curvature denotes that the portion of the concave work surface 16 closest to the apex 14 has a curvature with the smallest radii and the portion of the concave surface 16 having the greatest radii corresponds to the rear of the vortex generator 15 at which the vortices exit, wherein the curvature of the concave surface 16 increases from the apex 14 to the rear 19 of the vortex generator 15.

Referring to FIG. 7, in one embodiment the concave work surface 16 further includes a channel 30 having a planar surface at the base of the concave work surface. The term planar denotes that the channel has substantially no curvature. In one embodiment, the channel surface 30 has a width W3 ranging from approximately 10 mm to approximately 40 mm. In one embodiment, the channel surface 30 has a width W3 of approximately 30 mm.

Referring to FIGS. 3-6, the first and second sidewalls 17, 18 adjoin the concave work surface 16 at the upper edge 20, 21 of each of the first and second sidewall 17, 18, which is also referred to as the peak of the first and second sidewall 17, 18. Referring to FIG. 5, in one embodiment, the exterior face of each of the first and second sidewalls 17, 18 may include a convex surface 17a, 18a. The exterior face of the sidewalls 17, 18 of the vortex generator 15 extend from the lower edges 26, 27 to the upper edge 20, 21 of the sidewall. The upper edge of the sidewall 17 is also referred to as the sidewall's upper peak. In one embodiment, the exterior face of each of the first and second sidewalls 17, 18 may include a convex surface 17a, 18a in an upper portion of the sidewall, and a concave surface 17b, 18b in a lower portion of the sidewall, in which the convex and concave surfaces are designated relative to the vortex generator centerline AB.

More particularly, the apex of curvature of the convex sidewall portions face away from the centerline AB of the vortex generator 15, and the apex of the concave sidewall portions face towards the centerline AB of the vortex generator 15. In one embodiment, the concave and convex portions of the sidewalls 17, 18 have a cone geometry curvature. The term cone configuration denotes that the portion of the concave or convex surface 17a, 17b, 18a, 18b of the sidewalls 17, 18 that is closest to the apex 14 has a curvature with the smallest radii and the portion of the concave or convex surface 17a, 17b, 18a, 18b of the sidewalls 17, 18 having the greatest radii corresponds to the rear portion 19 of the vortex generator 15 at which the vortices exit, wherein the curvature of the concave or convex surface 17a, 17b, 18a, 18b of the sidewalls 17, 18 increases from the apex 14 to the rear 19 of the vortex generator 15.

Referring to FIG. 7, in one embodiment, the exterior face of the sidewalls 17, 18 of the vortex generator 15 are substantially planar. The sidewall angle θ is defined by the intersection between the sidewall 17, 18 and the base mount surface defined by the plane HGEF, wherein the angle θ may range from approximately 45° to approximately 75°. In another embodiment, the angle θ may range from approximately 50° to approximately 70°.

Referring to FIGS. 3-7, opposite the upper edges 20, 21 of each of the first and second sidewall 17, 18 is lower edges 26, 27. The lower edges 26, 27 represent the portion of the sidewall that contact the mounting surface or correspond to the base of the vortex generator 15. The lower edge angle α is defined by the lower edge 27 of the sidewall 18, and is measured at the intersection of a ray 51 to the rear corner 50 of the vortex generator 15, wherein the ray 51 is on the same plane as the base mount surface, defined by the plane HGEF, and is the parallel to the longitudinal centerline AB of the vortex generator 15. In one embodiment, the lower edge angle α may range from about 10° to about 30°. Increasing the lower edge angle increases vortex formation, and may also increase the intrinsic aerodynamic drag of the vortex generator 15. The intrinsic aerodynamic drag is the drag resulting from the vortex generator 15 itself. Although, the description of the lower edge angle α is described with reference to the sidewall indicated by reference number 18, it is noted that the same relationship is present with respect to the sidewall indicated by reference number 17.

In one embodiment, the portion of the vortex generator to one side of the longitudinal centerline AB is substantially similar to the portion of the vortex generator on the other side of the longitudinal centerline AB. More specifically, in one embodiment the curvatures and dimensions of the vortex generator 15 on one side of the longitudinal centerline AB are substantially similar to the curvatures and dimensions on the other side of the longitudinal centerline AB, and are hence symmetrical.

Referring to FIGS. 6, in one embodiment, the first and second sidewalls 17, 18 and concave work surface 16 of the vortex generator 15 produces vortices having an axle of rotation parallel substantially parallel to the longitudinal direction of the concave work surface 16, and may have an axis of rotation substantially parallel to the direction in which the airflow enters and then exits the vortex generator 15. Referring to FIG. 6, airflow 23 directed past the apex 14 of the vortex generator 15 flows around the first and second sidewalls 17, 18; over the upper edge 20, 21 of each of the first and second sidewalls 17, 18; and into the concave work surface 16 prior to exiting the rear 19 of the vortex generators. In one embodiment, the sidewall 17, 18 prepare airflow in initiating vortex generation; the upper edges 20, 21 direct the forming vortices into the concave work surface 16, wherein when passing over the upper edges 20, 21 the airflow swirls forming two vortices with a rotational axis directed along the direction of the main airflow; and the concave work surface 16 maintains the vortices and directs the vortices 24 upon exiting the vortex generators 15. In one embodiment, the degree at which rotational axis y is parallel to the direction in which the vehicle is moving may be adjusted by increasing or decreasing the angle of inclination β of the concave work surface 16.

In one embodiment, the airflow to the concave work surface 16 is separated from the airflow directed into the concave work surface 16 by the sidewalls 17, 18. FIGS. 8 and 9 depict one embodiment in which the separation of the airflow to the concave work surface 16 and the airflow directed into the concave work surface by the sidewalls 17, 18 is enhanced by an enlarged apex. In one embodiment, the enlarged apex 14a includes an enlarged convex sidewall portion 18c positioned at the upper portion of each sidewall. In one embodiment, the convex edge 18c on the upper portion of the apex portion of the sidewall increases the degree at which the airflow is directed towards the concave work surface 16 of the vortex generator 15.

Referring to FIG. 10, in one embodiment, the airflow exits the rear 19 (outlet) of the vortex generator 15 as two substantially symmetrical vortices each corresponding to a sidewall 17, 18, in which the airflow of each vortices encircles an axis of rotation that is substantially parallel to the longitudinal direction of the vortex generator 15 defined from the vortex generator's apex 14 to the vortex generator's rear 19. Referring to FIG. 11, in one embodiment, the rotation axis y by which the vortices 24 swirl may be controlled by the angle of inclination β of the concave work surface 16.

In one embodiment, the concave work surface 16 may be inclined from the apex 14 to the rear face 19 by an angle β measured from the base mount surface defined by the plane HEFG to the base of the concave work surface 16, wherein the base of the concave work surface 16 extends from the apex 14 to the lowest point 22 of the concave work surface 16 at the rear face 19 of the vortex generator 15, as depicted in FIGS. 3 and 4. In one embodiment, the lowest point 22 of the concave work surface 16 at the rear face 19 of the vortex generator 15 may have a height ranging from about 5 mm to about 15 mm. In one embodiment, in which the angle of inclination β to the concave work surface 16 is substantially 0°, as depicted in FIGS. 12 and 13, the vortices produced by the vortex generator 15 have an axis of rotation substantially parallel to the direction the air flow passes the vortex generator 15. In one embodiment, a vortex generator 15 having an angle of inclination β of substantially 0° mounted to the lateral surfaces of a trailer produces vortices having an axis of rotation being substantially parallel to the direction in which the surface on which the vortex generator 15 is mounted is moving. In one embodiment, a vortex generator 15 having an angle of inclination β of substantially 0° is mounted to a surface to reduce the effects of airflow separation.

Referring to FIG. 14 in one embodiment, the angle of inclination β is selected to provide an angle γ for the axis of rotation of the vortices in order to direct the airflow past the front surfaces 3 of the tractor 8 (angle γ1) and the front surface the trailer 9 (angle γ2) that are positioned behind the point at which the vortex generator is mounted. In one embodiment, the angle of inclination from the apex 14 to the rear face 19 of the lowest portion of the concave work surface 16 may range from about 0° to about 45°. In one embodiment, the angle of inclination from the apex 14 to the rear face 19 of the lowest portion of the concave work surface 16 may range from about 15° to about 30°. It is noted that the angle of inclination β may be varied to satisfy any combination of tractor 8 and trailer 9 heights. In one embodiment, vortex generators 15 having an angle of inclination β selected to direct airflow past the front surfaces of the tractor 9 and trailer 8 may be combined with vortex generators 15 connected to the top and side surfaces of the trailer 8 having angle of inclination β to reduce the effects of airflow separation.

Referring to FIG. 4, in one embodiment, the height H of the vortex generator 15 at its rear face 19 (also referred to as outlet portion) is determined by the thickness of the boundary layer of the airflow in the area where the vortex generator is installed. In one embodiment, the height H of the vortex generator 15 may be no less than the thickness of the boundary layer to ensure interaction with the flow having a sufficient energy to disrupt flow in providing vortices; and may not be so great as to avoid increasing the intrinsic aerodynamic drag of the vortex generator 15 to a point that outweigh the advantages provided by the formation of the symmetrical vortices having an axis of rotation substantially parallel to the vehicles direction of motion. In one embodiment, the height H of the vortex generator 15 may range from about 20 mm to about 40 mm.

FIG. 15 depicts a plurality of vortex generators 15 arranged atop the surface of a tractor fairing 8. It is noted that the each vortex generator 15 may be separated from their adjacent vortex generator 15, as depicted in FIG. 15, or each vortex generator 15a may be positioned in abutting relationship to their adjacent vortex generator 15b, as depicted in FIG. 16. An abutting relationship denotes that the sidewalls of the adjacent vortex generators 15a, 15b are positioned in direct contact with one another and in one embodiment increases the density of vortex generators in providing an increased air curtain. FIG. 17 depicts one embodiment of a vortex generator 15a configured for arrangement in abutting relationship to an adjacent vortex generator 15b, as depicted in FIG. 16. In one embodiment, the sidewalls 17, 18 of adjacent vortex generators 15a, 15b are sectioned to provide a substantially planar mating surface 25 in order to arrange the adjacent vortex generators 15a, 15b in an abutting relationship.

FIGS. 18 and 19 depict another embodiment of a vortex generator 15c, wherein the concave work surface 16 includes a longitudinal partition 28. In one embodiment, the height of the longitudinal partition 28 increases in the direction of airflow. In one embodiment, the longitudinal partition 28 decreases the incidence of parasitic vortices P that may be formed in embodiments of the present invention that do not include the longitudinal partition, as depicted in FIG. 10. The formation of two vortices in a vortex generator 15c including a longitudinal partition 28 is depicted in FIG. 19. FIGS. 20 and 21 depict another embodiment of the vortex generator 15d, in accordance with the present invention, in which the intrinsic drag of the vortex generator 15 is reduced by providing a curvature 19a at the outlet of the vortex generator 15d.

In one embodiment, the vortex generator 15 may be manufactured by stamping from a sheet material, as depicted in FIG. 3. The vortex generator 15 may be manufactured as an individual product, which is to be mounted adhesively or mechanically on structural components interacting with airflow. In another embodiment, vortex generator 1 could be stamped as a single whole in conjunction with a structural component, such as an automotive body component, and may include a plurality of vortex generators 15. In one embodiment, the vortex generator 15 or structural component 13 is composed of an aluminum alloy.

Referring to FIG. 22, the vortex generator 1 may also be manufactured by casting, in particular, as an individual article, which is subsequently installed on other structural components interacting with the airflow. In another embodiment, the vortex generator 15 may be cast as a single or plurality of vortex generators in combination with a structural component 13, for example, with a roof fairing. In one embodiment, the vortex generator 15 or structural component 13 is composed of an aluminum alloy.

While a number of embodiments of the present invention have been described, it is understood that these embodiments are illustrative only, and not restrictive, and that many modifications may become apparent to those of ordinary skill in the art.

What is claimed is:

1. A vortex generator including:
an apex having a first width;
a rear face having a second width being greater than the first width;
a first and second sidewall each extending from the first width of the apex to the second width of the rear face, wherein at least a portion of an exterior face of each of the first and second sidewall have a peak including a convex surface; and
a concave work surface positioned between the peak of the first and the second sidewall, wherein the concave work surface has an intake at the apex and an outlet at the rear face.

2. The vortex generator of claim 1, wherein the peak of the first and second sidewall is in an upper portion of the sidewall and the first and second sidewall further comprise a concave portion positioned in a lower portion of the first and second sidewall.

3. The vortex generator of claim 1, wherein the convex surface of the peak of the first and second sidewall have a cone geometry, in which the convex surface comprises a radii of curvature that increases from an initial radii at the apex of the vortex generator to a final radii at the rear face of the vortex generator.

4. The vortex generator of claim 1, wherein the concave surface of the sidewall comprises a cone geometry curvature, wherein the concave surface comprises a radii of curvature that increases from an initial radii at the apex of the vortex generator to a final radii at the rear face of the vortex generator.

5. The vortex generator of claim 1, wherein the concave work surface comprises a cone geometry curvature, wherein to cone geometry curvature comprises a radii of curvature that increases from an initial radii at the apex of the vortex generator to a final radii at the rear face of the vortex generator.

6. The vortex generator of claim 1, wherein the concave work surface comprises a substantially planar channel centrally positioned between a concave curvature extending from the peaks of each of the first and second sidewall.

7. The vortex generator of claim 1, wherein the concave surface further comprises a substantially planar channel at the base of the concave surface extending from the intake of the apex to the outlet of the rear portion of the vortex generator.

8. The vortex generator of claim 1, wherein the concave work surface comprises a longitudinal partition corresponding to the centerline of the vortex generator.

9. The vortex generator of claim 1, wherein the concave work surface comprises an angle of inclination that may range from about 0° to about 45°.

10. The vortex generator of claim 1, comprising a longitudinal length ranging from approximately 140 mm to approximately 190 mm.

11. The vortex generator of claim 1 comprising an aluminum alloy.

12. A vortex generator including:
an apex having a first width;
a rear face having a second width being greater than the first width;
a first and second sidewall each extending from the first width of the apex to the second width of the rear face; and
a concave work surface positioned between the first and the second sidewall,
wherein the concave work surface has an intake at the apex and an outlet at the rear face.

13. The vortex generator of claim 11 wherein each of the first and second sidewalls have a substantially planar exterior face.

14. The vortex generator of claim 11, wherein the concave work surface comprises a cone geometry curvature, wherein to cone geometry curvature comprises a radii of curvature that increases from an initial radii at the apex of the vortex generator to a final radii at the rear face of the vortex generator.

15. The vortex generator of claim 11, wherein the concave surface further comprises a substantially planar channel at the base of the concave surface extending from the intake of the apex to the outlet of the rear portion of the vortex generator.

16. The vortex generator of claim 14 wherein the substantially planar channel has a width ranging from approximately 10 mm to approximately 40 mm.

17. The vortex generator of claim 11 wherein the interior angle defined the intersection of the first and second sidewall to a planar mounting surface ranges from about 45° to 75°.

18. The vortex generator of claim 11 wherein the angle at which the base edge of first and second sidewalls diverges from the first width of the apex to the second width of the rear portion of the vortex generator ranges from about 10° to about 30°.

19. The vortex generator of claim 11 comprising an aluminum alloy.
